(19) United States
(12) Patent Application Publication
(10) Pub. No.: US 2015/0102891 A1
(43) Pub. Date: Apr. 16, 2015

(54) CHIP ELECTRONIC COMPONENT, BOARD HAVING THE SAME, AND PACKAGING UNIT THEREOF

(71) Applicant: SAMSUNG ELECTRO-MECHANICS CO., LTD., Suwon (KR)

(72) Inventors: Chan YOON, Suwon (KR); Dong Hwan LEE, Suwon (KR); Jin Woo HAN, Suwon (KR)

(73) Assignee: SAMSUNG ELECTRO-MECHANICS CO., LTD., Suwon (KR)

(21) Appl. No.: 14/505,012

(22) Filed: Oct. 2, 2014

(30) Foreign Application Priority Data
Oct. 16, 2013 (KR) 10-2013-0123541
Jul. 15, 2014 (KR) 10-2014-0089249

(51) Int. Cl. H01F 27/28

(52) U.S. Cl. CPC H01F 27/2804; H01F 2027/2819
USPC 336/200

(57) ABSTRACT

A chip electronic component may include: a magnetic body having first and second main surfaces opposing each other in a thickness direction, first and second side surfaces opposing each other in a width direction, and first and second end surfaces opposing each other in a length direction, a thickness of the magnetic body being greater than a width thereof; internal coil pattern parts disposed in the magnetic body; and external electrodes disposed on at least one surface of the magnetic body. The internal coil pattern parts may be disposed to be perpendicular with respect to the first and second main surfaces of the magnetic body.

### CROSS-REFERENCE TO RELATED APPLICATIONS

This application claims the foreign priority benefit of Korean Patent Application No. 10-2013-0123541 filed on Oct. 16, 2013 and Korean Patent Application No. 10-2014-0089249 filed on Jul. 15, 2014 with the Korean Intellectual Property Office, the disclosures of which are incorporated herein by reference.

### BACKGROUND

### 1. Field

The present disclosure relates to a chip electronic component, a board having the same, and a packaging unit thereof.

An inductor, a chip electronic component, is a representative passive element configuring an electronic circuit together with a resistor and a capacitor to remove noise.

A thin type inductor is manufactured by stacking, pressing, and curing a magnetic sheet formed by mixing a magnetic powder and a resin with each other after forming an internal coil pattern part.

### SUMMARY

Additional aspects and/or advantages will be set forth in part in the description which follows and, in part, will be apparent from the description, or may be learned by practice of the invention.

An exemplary embodiment may provide a chip electronic component capable of implementing high inductance (Ls) and an improved quality factor (Q) while having a reduced size thereof, a board having the same, and a packaging unit thereof.

According to an exemplary embodiment, a chip electronic component may include: a magnetic body having first and second main surfaces opposing each other in a thickness direction, first and second side surfaces opposing each other in a width direction, and first and second end surfaces opposing each other in a length direction, a thickness of the magnetic body being greater than a width thereof; internal coil pattern parts disposed in the magnetic body; and external electrodes disposed on at least one surface of the magnetic body, wherein the internal coil pattern parts are disposed to be perpendicular with respect to the first and second main surfaces of the magnetic body.

The magnetic body may have about a1608 size or smaller.

According to an exemplary embodiment, a board having a chip electronic component may include: a printed circuit board having electrode pads disposed thereon; and a chip electronic component mounted on the printed circuit board such that external electrodes are positioned on the electrode pads, wherein the chip electronic component includes a magnetic body having first and second main surfaces opposing each other in a thickness direction, first and second side surfaces opposing each other in a width direction, and first and second end surfaces opposing each other in a length direction, a thickness of the magnetic body being greater than a width thereof, internal coil pattern parts disposed in the magnetic body, and the external electrodes disposed on at least one surface of the magnetic body, the internal coil pattern parts being disposed to be perpendicular with respect to a mounting surface of the printed circuit board.

The board having a chip electronic component may further include a semiconductor chip (IC) mounted on the printed circuit board, wherein the chip electronic component has a thickness equal to or smaller than that of the semiconductor chip IC mounted on the printed circuit board.

According to an exemplary embodiment, a packaging unit of a chip electronic component may include: the chip electronic component as described above; and a packaging sheet including a receiving part formed therein so as to receive the chip electronic component therein, wherein the internal coil pattern parts are disposed and arranged to be perpendicular with respect to a bottom surface of the receiving part.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other aspects, features and other advantages in the present disclosure will be more clearly understood from the following detailed description taken in conjunction with the accompanying drawings, in which:

FIG. 1 is a schematic perspective view illustrating a chip electronic component according to an exemplary embodiment, in which internal coil pattern parts thereof are shown;

FIG. 2 is a partially cut-away perspective view of the chip electronic component according to an exemplary embodiment;

FIG. 3 is a cross-sectional view taken along line A-A′ of FIG. 1;

FIG. 4 is a schematic perspective view illustrating a chip electronic component according to another exemplary embodiment, in which internal coil pattern parts thereof are shown;

FIG. 5 is a cross-sectional view taken along line B-B′ of FIG. 4;

FIG. 6 is a schematic perspective view illustrating a chip electronic component according to another exemplary embodiment, in which internal coil pattern parts thereof are shown;

FIG. 7 is a cross-sectional view taken along line C-C′ of FIG. 6;

FIG. 8 is a perspective view illustrating a board having a chip electronic component according to an exemplary embodiment;

FIG. 9 is an enlarged view of part ‘E’ of FIG. 8 illustrating the chip electronic component mounted on the board according to an exemplary embodiment;

FIG. 10 is a perspective view illustrating a chip electronic component mounted on a board according to an exemplary embodiment;

FIG. 11 is a perspective view illustrating a chip electronic component mounted on a board according to an exemplary embodiment;

FIG. 12A is a view illustrating magnetic flux distribution in a chip electronic component in which internal coil pattern parts having a horizontal structure according to the related art are formed, and FIG. 12B is a view illustrating magnetic flux distribution in a chip electric component in which internal coil pattern parts having a vertical structure according to an exemplary embodiment are formed;

FIG. 13 is a schematic perspective view illustrating a form in which the chip electronic component according to an exemplary embodiment is mounted in a packaging unit; and

FIG. 14 is a schematic cross-sectional view illustrating a form in which the packaging unit of FIG. 13 is wound in a reel shape.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

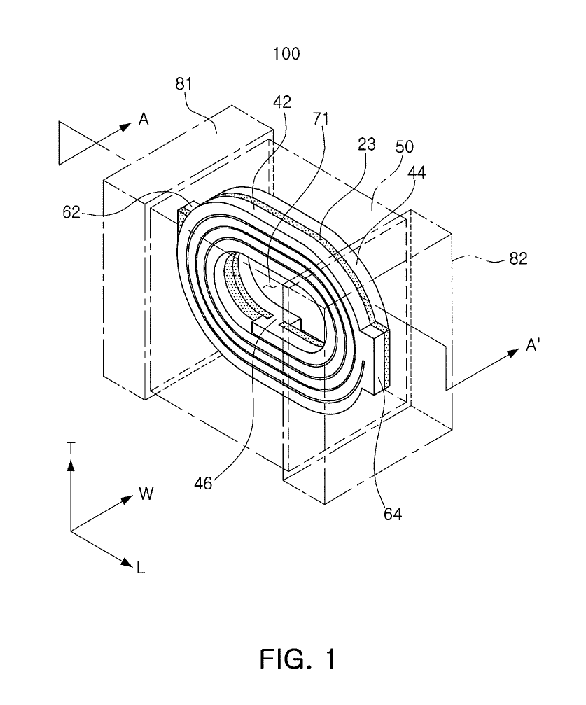

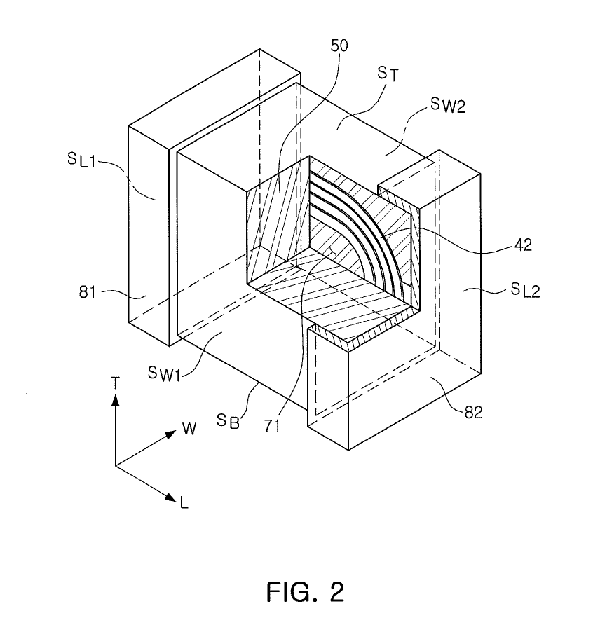

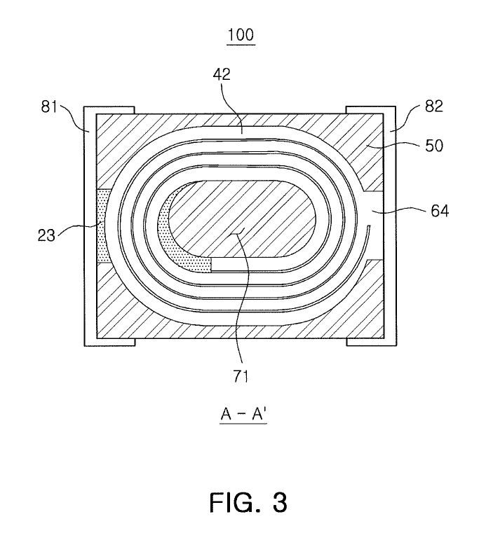

FIG. 1 is a schematic perspective view illustrating a chip electronic component according to an exemplary embodiment, in which internal coil pattern parts thereof are shown. FIG. 2 is a partially cut-away perspective view of the chip electronic component according to an exemplary embodiment. FIG. 3 is a cross-sectional view taken along line A-A′ of FIG. 1.

Referring to FIGS. 1 through 3, as an example of the chip electronic component, a thin type inductor 100 used in a power line of a power supply circuit is disclosed.

The thin type inductor 100 according to an exemplary embodiment may include a magnetic body 50, internal coil pattern parts 42 and 44 disposed in the magnetic body 50, and external electrodes 81 and 82 disposed on external portions of the magnetic body 50.

In the thin type inductor 100 according to an exemplary embodiment, a ‘length’ direction refers to an ‘L’ direction of FIG. 1, a ‘width’ direction refers to a ‘W’ direction of FIG. 1, and a ‘thickness’ direction refers to a ‘T’ direction of FIG. 1.

The magnetic body 50 may have first and second main surfaces S_{B} and S_{T} opposing each other in the thickness direction, first and second end surfaces S_{L1} and S_{L2} opposing each other in the length direction, and first and second side surfaces S_{W1} and S_{W2} opposing each other in the width direction.

As a size of the thin type inductor 100 according to an exemplary embodiment is reduced, the magnetic body 50 may have a thickness T greater than a width W thereof.

According to the related art, in the cases of a 2012-sized chip (length: 2.0 mm×width: 1.2 mm), a 2520-sized chip (length: 2.5 mm×width: 2.0 mm), and the like, that are greater than a 1608-sized chip, a thickness T of a magnetic body thereof was about 1.0 mm, smaller than a width W thereof.

However, as the size of the thin type inductor 100 is reduced to 1608 size or smaller in accordance with the demand for miniaturization of a chip electronic component, a magnetic body having a thickness T greater than a width W is formed.

The reason for this is that when the size of thin type inductor 100 is reduced, performance properties of the inductor such as inductance (Ls), a quality factor (Q), and the like, may be deteriorated, but in order to secure excellent performance of the inductor even in the case in which the size is reduced, the thickness T of the magnetic body needs to be maintained even when a length L and the width W of the magnetic body are decreased during a miniaturization process.

Particularly, in a power inductor used in a power line of a power supply circuit, in the case in which performance thereof is deteriorated due to a decrease in a size thereof, power conversion efficiency may be rapidly deteriorated. Accordingly, the magnetic body may have a shape in which the thickness T thereof is greater than the width W thereof by decreasing the length L and the width W of the magnetic body while maintaining the thickness T as much as possible in order to secure excellent performance of the inductor.

In this case, a thin type power inductor may have a maximum thickness T in a level similar to a thickness of a semiconductor chip (IC) such as a power management integrated circuit (PMIC), an application processor (AP), or the like, positioned in the power supply circuit.

The size of the thin type inductor 100 according to an exemplary embodiment in the present disclosure may be in a range in which a length of the magnetic body 50 is about 1.6±0.2 mm and a width thereof is about 0.8±0.2 mm (1608 size) in a state in which the external electrodes 81 and 82 are not included. Alternatively, the thin type inductor 100 may have the 1608 size or smaller.

For example, in the case of the 1608 size structure, when the length of the magnetic body 50 is about 1.6±0.2 mm and the width thereof is about 0.8±0.2 mm, the magnetic body 50 may have the thickness T greater than the width W within a range in which the thickness about T is 1.0±0.2 mm.

In the thin type inductor 100 according to an exemplary embodiment, since the magnetic body 50 has a 1608 size or smaller and the thickness T thereof is greater than the width W thereof, a cross-sectional area of the magnetic body 50 in an L-T direction is greater than that of the magnetic body in an L-W direction.

The magnetic body 50 may form the exterior of the thin type inductor 100 and may be formed of any material having magnetic properties, without limitation. For example, the magnetic body 50 may be formed by filling a ferrite material or a metal-based soft magnetic material.

Examples of the ferrite material may include ferrite materials commonly known in the art, such as Mn—Zn based ferrite, Ni—Zn based ferrite, Ni—Zn—Cu based ferrite, Mn—Mg based ferrite, Ba based ferrite, Li based ferrite, or the like.

The metal-based soft magnetic material may be an alloy containing at least one selected from a group consisting of Fe, Si, Cr, Al, and Ni. For example, the metal-based soft magnetic material may be a Fe—Si—B—Cr based amorphous metal powder, but the present disclosure is not limited thereto.

The metal-based soft magnetic material may have a particle diameter of 0.1 to 30 μm, and particles thereof may be dispersed in a polymer such as an epoxy resin, polyimide, or the like.

The internal coil pattern parts 42 and 44 disposed in the magnetic body 50 may be formed on at least one surface of an insulating substrate 23.

Examples of the insulating substrate 23 may include a polypropylene glycol (PPG) substrate, a ferrite substrate, a metal-based soft magnetic substrate, and the like.

The insulating substrate 23 may have a hole penetrating through a central portion thereof, and the hole may be filled with a magnetic material such as ferrite, a metal-based soft magnetic material, or the like, to form a core part 71. The core part 71 filled with the magnetic material may be formed, such that inductance (Ls) may be increased. As an area of the core part 71 is increased, inductance (Ls) may be further improved.

The internal coil pattern part 44 having coil patterns may be formed on one surface of the insulating substrate 23, and the internal coil pattern part 42 having coil patterns may be also formed on the other surface of the insulating substrate 23.

The internal coil pattern parts 42 and 44 may be formed on the insulating substrate 23 by plating and have a planar coil pattern shape.

According to an exemplary embodiment, the internal coil pattern parts 42 and 44 may be disposed to be perpendicular with respect to the first and second main surfaces S_{B} and S_{T} of the magnetic body 50.

Forming the internal coil pattern parts 42 and 44 to be perpendicular with respect to the first and second main surfaces S_{B} and S_{T} of the magnetic body 50, indicates that the surfaces of the internal coil pattern parts 42 and 44 contacting the insulating substrate 23 are disposed to have an angle of 90° or an angle of substantially 90° with respect to the first or second main surface S_{B} or S_{T} of the magnetic body 50 as illustrated in FIG. 1. For example, the internal coil pattern parts 42 and 44 may be formed to be upright with respect to the first or second main surface S_{B} or S_{T} of the magnetic body 50 such that an angle between the internal coil pattern parts 42 and 44 and the first or second main surface S_{B} or S_{T} of the magnetic body 50 is between 80° to 100°.

Meanwhile, the internal coil pattern parts 42 and 44 may be formed to be parallel to the first and second side surfaces S_{W1} and S_{W2} of the magnetic body 50. That is, the surfaces of the internal coil pattern parts 42 and 44 contacting the insulating substrate 23 may be parallel to the first and second side surfaces S_{W1} and S_{W2} of the magnetic body 50.

As described above, as the thin type inductor 100 is miniaturized to have a 1608 size or smaller, the magnetic body 50 of which the thickness T is greater than the width W may be formed, and the cross-sectional area of the magnetic body 50 in the L-T direction may be greater than that of the magnetic body 50 in the L-W direction.

Therefore, as the internal coil pattern parts 42 and 44 are formed to be perpendicular with respect to the first and second main surfaces S_{B} and S_{T} of the magnetic body 50, an area of a region in which the internal coil pattern parts 42 and 44 may be formed may be increased.

For example, according to an exemplary embodiment, when the length of the magnetic body 50 is in a range of about 1.6±0.2 mm and the width thereof is in a range of about 0.8±0.2 mm (1608 size), the thickness T thereof may be greater than the width W thereof in a range in which the thickness T is about 1.0±0.2 mm. However, since the thickness T of the magnetic body 50 is greater than the width W thereof, when the internal coil pattern parts 42 and 44 are formed to be perpendicular with respect to the first and second main surfaces S_{B} and S_{T} of the magnetic body 50, a larger area may be secured, as compared to a case in which the internal coil pattern parts 42 and 44 are formed to be parallel to the first and second main surfaces S_{B} and S_{T} of the magnetic body 50.

As the size of the thin type inductor is reduced and an internal space of the magnetic body in which an internal coil pattern part may be formed is decreased, it may be difficult to secure high inductance (Ls) and a width of the internal coil pattern part may be decreased, such that direct current resistance and alternative current resistance may be increased, and further, the quality factor (Q) may be deteriorated.

Therefore, according to an exemplary embodiment, the internal coil pattern parts 42 and 44 may be disposed to be perpendicular with respect to the first and second main surfaces S_{B} and S_{T} of the magnetic body 50, such that the area of the region in which the internal coil pattern parts 42 and 44 are formed in the magnetic body 50 may be increased, and inductance (Ls) and the quality factor (Q) may be improved.

However, in the cases of the 2012-sized chip (length: 2.0 mm×width: 1.2 mm), the 2520-sized chip (length: 2.5 mm×width: 2.0 mm), and the like, that are greater than the 1608-sized chip, since they are manufactured to have a thickness T of about 1 mm, similarly to a thickness of the semiconductor chip (IC), they have a thickness T smaller than a width W thereof.

Therefore, in the thin type inductor having a size greater than the 1608 size, since the cross-sectional area of the magnetic body in the L-T direction is smaller than that of the magnetic body in the L-W direction, it is not preferable to dispose the internal coil pattern part to be perpendicular with respect to the main surface of the magnetic body.

In addition to the above-mentioned 1608 size, in the thin type inductor 100 having a 1608 size or smaller according to an exemplary embodiment, when the magnetic body 50 has a length of about 1.0±0.2 mm and a width of about 0.5±0.2 mm (1005 size), the magnetic body 50 may have the thickness T greater than the width W thereof in a range in which the thickness T is about 0.8±0.2 mm.

In addition, when the magnetic body 50 has a length of about 0.6±0.1 mm and a width of about 0.3±0.1 mm (0603 size), the magnetic body 50 may have the thickness T greater than the width W thereof in a range in which the thickness T is about 0.5±0.2 mm.

Further, when the magnetic body 50 has a length of about 0.4±0.1 mm and a width of about 0.2±0.1 mm (0402 size), the magnetic body 50 may have the thickness T greater than the width W thereof in a range in which the thickness T is about 0.3±0.2 mm.

However, the present disclosure is not limited thereto, and any thin type inductor including a magnetic body having about a 1608 size or smaller and having a thickness greater than a width thereof may be included in the scope of the present invention.

The internal coil pattern parts 42 and 44 formed on one surface and the other surface of the insulating substrate 23 may be electrically connected to each other through a via electrode 46 formed in the insulating substrate 23.

The internal coil pattern parts 42 and 44 and the electrode 46 may be formed of a metal having excellent electrical conductivity. For example, the internal coil pattern parts 42 and 44 and the via electrode 46 may be formed of silver (Ag), palladium (Pd), aluminum (Al), nickel (Ni), titanium (Ti), gold (Au), copper (Cu), or platinum (Pt), or an alloy thereof, or the like.

According to an exemplary embodiment, an end portion of the internal coil pattern part 44 formed on one surface of the insulating substrate 23 may be extended to form a first lead part 62, and the first lead part 62 may be exposed to the first end surface S_{L1} of the magnetic body 50. Further, an end portion of the internal coil pattern part 42 formed on the other surface of the insulating substrate 23 may be extended to form a second lead part 64, and the second lead part 64 may be exposed to the second end surface S_{L2} of the magnetic body 50.

The first and second external electrodes 81 and 82 may be disposed on the first and second end surfaces S_{L1} and S_{L2} of the magnetic body 50 to be connected to the first and second lead parts 62 and 64 exposed to the first and second end surfaces S_{L1} and S_{L2} of the magnetic body 50, respectively. The first and second external electrodes 81 and 82 may be extended to the first and second main surfaces S_{B} and S_{T} and first and second side surfaces S_{W1} and S_{W2} of the magnetic body 50.

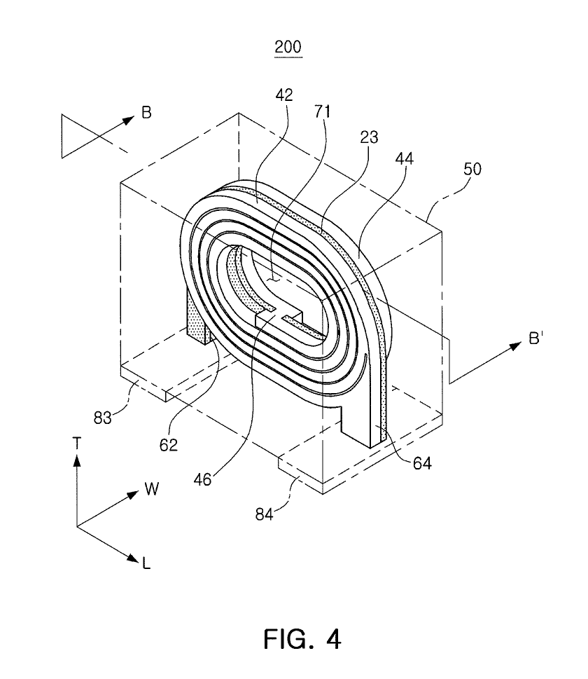

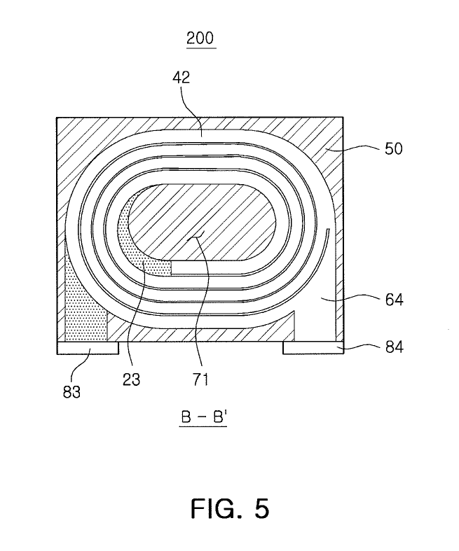

FIG. 4 is a schematic perspective view illustrating a chip electronic component according to an exemplary embodiment, in which internal coil pattern parts thereof are shown. FIG. 5 is a cross-sectional view taken along line B-B′ of FIG. 4.

Hereinafter, components different from those of the above-mentioned embodiments may be mainly described and a detailed description of the same components as those of the above-mentioned embodiments will be omitted.

Referring to FIGS. 4 and 5, in a thin type inductor 200 according to an exemplary embodiment, the internal coil pattern parts 42 and 44 may include the second and first lead parts 64 and 62 respectively extended from the end portion thereof and led-out to the first main surface S_{B} of the magnetic body 50.

The first lead part 62 may be extended from one end portion of the internal coil pattern part 44 formed on one surface of the insulating substrate 23 and the second lead part 64 may be extended from one end portion of the internal coil pattern part 42 formed on the other surface of the insulating substrate 23. Therefore, the first and second lead parts 62 and 64 are formed on one surface and the other surface of the insulating substrate 23, respectively.

First and second external electrodes 83 and 84 may be disposed on the first main surface S_{B} of the magnetic body 50 to be connected to the first and second lead parts 62 and 64 led-out to the first main surface S_{B} of the magnetic body 50, respectively.

As the first and second external electrodes 83 and 84 are formed on the first main surface S_{B} of the magnetic body 50, an influence of the external electrodes hindering a flow of magnetic flux may be decreased, such that performance properties of the inductor such as inductance (Ls) and the quality factor (Q), and the like, may be further improved.

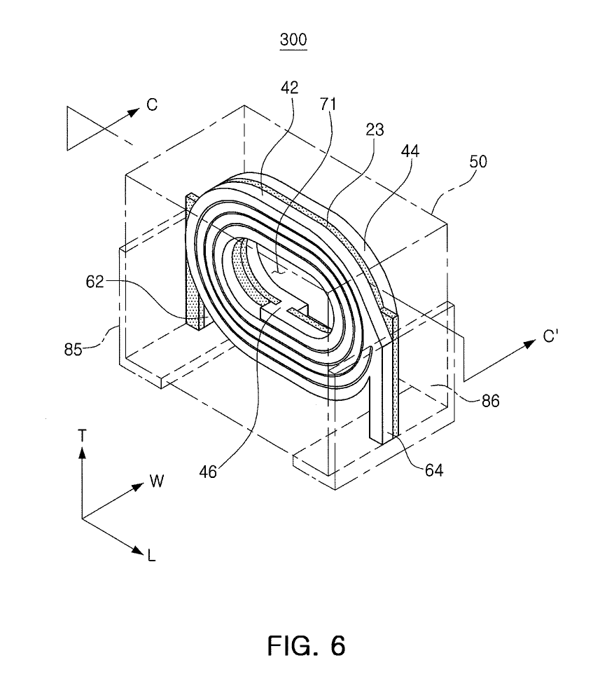

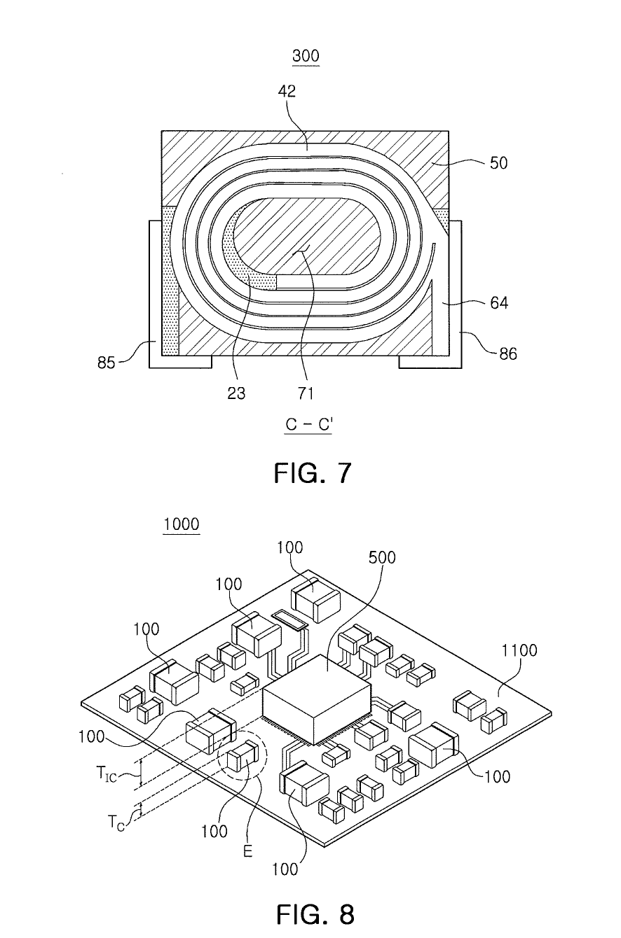

FIG. 6 is a schematic perspective view illustrating a chip electronic component according to an exemplary embodiment, in which internal coil pattern parts thereof are shown. FIG. 7 is a cross-sectional view taken along line C-C′ of FIG. 6.

Hereinafter, components different from those of the above-mentioned embodiments may be mainly described and a detailed description of the same components as those of the above-mentioned embodiments will be omitted.

Referring to FIGS. 6 and 7, in a thin type inductor 300 according to an exemplary embodiment, the internal coil pattern parts 42 and 44 may include the second and first lead parts 64 and 62 extended from the end portion thereof and led-out to the second and first end surfaces S_{L2} and S_{L1} of the magnetic body 50, respectively, while being led-out to the first main surface S_{B} of the magnetic body 50.

A first external electrode 85 may be disposed on the first main surface S_{B} of the magnetic body 50 and the first end surface S_{L1} thereof adjacent to the first main surface S_{B} to be connected to the first lead part 62 led-out to the first main surface S_{B} of the magnetic body 50 and the first end surface S_{L1} thereof, and a second external electrode 86 may be disposed on the first main surface S_{B} of the magnetic body 50 and the second end surface S_{L2} thereof adjacent to the first main surface S_{B} to be connected to the second lead part 64 led-out to the first main surface S_{B} of the magnetic body 50 and the second end surface S_{L2} thereof.

As the first and second lead parts 62 and 64 are led-out to the first main surface S_{B} of the magnetic body 50 and the first and second end surfaces S_{L1} and S_{L2} thereof and the first and second external electrodes 85 and 86 are formed thereon as described above, an influence of the external electrodes hindering a flow of magnetic flux may be decreased while the internal coil pattern parts 42 and 44 may be extended to the first and second end surfaces S_{L1} and S_{L2} of the magnetic body 50. Therefore, an area in which the first and second internal coil pattern parts 42 and 44 may be formed may be increased, and an increase in inductance (Ls) may be implemented.

FIG. 8 is a perspective view illustrating a board having a chip electronic component according to an exemplary embodiment.

Referring to FIG. 8, a portion of a power supply circuit of a mobile phone is illustrated as an example of the board having a chip electronic component.

A board 1000 having a chip electronic component according to an exemplary embodiment may include a printed circuit board 1100 and the thin type inductor 100 mounted on the printed circuit board 1100.

As a portion of a power supply circuit, the board 1000 having a chip electronic component may further include a semiconductor chip (IC) 500 mounted on the printed circuit board 1100.

The semiconductor chip (IC) 500 positioned in the power supply circuit may be, for example, a power management integrated circuit (PMIC), an application processor (AP), or the like.

The thin type inductor 100, a power inductor used in the power supply circuit, may be mounted in a peripheral portion of the IC chip 500 to control a current during power conversion, thereby stabilizing a voltage.

In this case, since a space occupied by the power inductor is the largest in the power supply circuit, a decrease in a size of the power inductor may be necessarily required in order to implement miniaturization of the circuit.

Therefore, the size of the power inductor used in the power supply circuit is reduced from 2520 size (length: 2.5 mm×width: 2.0 mm), 2012 size (length: 2.0 mm×width: 1.2 mm), and the like, to 1608 size (length: 1.6 mm×width: 0.8 mm) or smaller.

However, in the case in which performance properties of the inductor such as inductance (Ls), quality factor (Q) thereof, and the like, are deteriorated due to a decrease in the size of the power inductor used in the power supply circuit, power conversion efficiency may be rapidly deteriorated.

Therefore, in order to secure excellent performance of the inductor and prevent a lowering of the power conversion efficiency, miniaturization of the inductor has been conducted in such a manner that a length L and a width W of a magnetic body thereof are decreased but a thickness T of the magnetic body is maintained as much as possible.

Meanwhile, since there is a limitation in decreasing a thickness tIC of the IC chip 500 used in the power supply circuit of the mobile phone, such as the power management integrated circuit (PMIC), the application processor (AP), or the like, the power inductor mounted in the peripheral portion of the IC 500 may have a maximum thickness tc similar to the thickness tIC of the IC chip 500.

That is, the thin type inductor 100, the power inductor according to an exemplary embodiment, may have a thickness equal to or smaller than that of the IC 500.

For example, since it is difficult to manufacture the IC 500 used in the power supply circuit of the mobile phone to have a thickness tIC of about 1 mm or less, the thin type inductor 100 mounted in the peripheral portion of the IC 500 may secure the thickness tc of about 1 mm.

Therefore, in the cases of a 2012-sized chip (length: 2.0 mm×width: 1.2 mm), a 2520-sized chip (length: 2.5 mm×width: 2.0 mm), and the like, that are greater than a 1608-sized chip, since they are manufactured to have a thickness T of about 1 mm, similarly to the thickness tIC of the IC 500, they have a thickness T smaller than a width W thereof.

Meanwhile, the thin type inductor 100 according to an exemplary embodiment may include the magnetic body 50 having the 1608 size or smaller and having the thickness T greater than the width W thereof by decreasing the length L and the width W of the magnetic body 50 but maintaining the thickness maximally at about 1 mm in such a manner that the magnetic body 50 has the 1608 size or smaller.

For example, in the case of the 1608 size structure, when the length of the magnetic body 50 is about 1.6±0.2 mm and the width thereof is about 0.8±0.2 mm, the magnetic body 50 has the thickness T greater than the width W in a range in which the thickness is about 1.0±0.2 mm.

Since the thin type inductor 100 according to an exemplary embodiment in the present disclosure has the 1608 size or smaller and the thickness T thereof is greater than the width W thereof, the cross-sectional area of the magnetic body 50 in the L-T direction is larger than that of the magnetic body in the L-W direction.

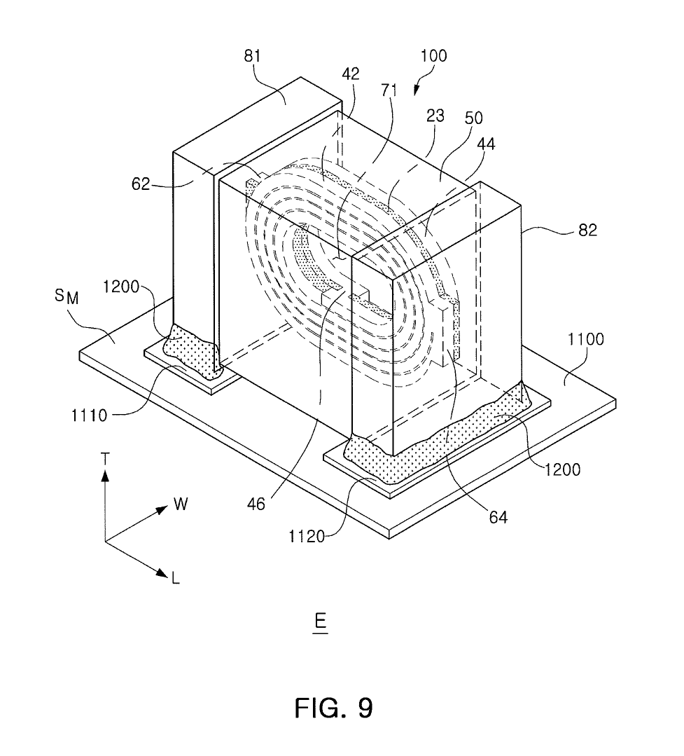

FIG. 9 is an enlarged view of part ‘E’ of FIG. 8 illustrating the chip electronic component mounted on the board according to an exemplary embodiment in the present disclosure.

Referring to FIG. 9, the board 1000 having the chip electronic component 100 according to an exemplary embodiment may include the printed circuit board 1100 on which the thin type inductor 100 is mounted and first and second electrode pads 1110 and 1120 disposed on the printed circuit board 1100.

In this case, the thin type inductor 100 may be electrically connected to the printed circuit board 1100 by soldering 1200 in a state in which the first and second external electrodes 81 and 82 are positioned on the first and second electrode pads 1110 and 1120 to come into contact with each other, respectively.

The thin type inductor 100 may be mounted such that the first main surface SB of the magnetic body 50 is formed on the printed circuit board 1100. That is, the first main surface SB of the magnetic body 50 is mounted to face a mounting surface SM of the printed circuit board 1100, and a direction of an axis perpendicular with respect to the mounting surface SM may be the thickness (T) direction of the thin type inductor 100.

In this case, the internal coil pattern parts 42 and 44 may be disposed to be perpendicular with respect to the mounting surface SM of the printed circuit board 1100 on which the thin type inductor 100 is mounted.

Disposing the internal coil pattern parts 42 and 44 to be perpendicular with respect to the mounting surface SM indicates that the surfaces of the internal coil pattern parts 42 and 44 contacting the insulating substrate 23 are disposed to have an angle of 90° or an angle of substantially 90° with respect to the mounting surface SM as illustrated in FIG. 9. For example, the internal coil pattern parts 42 and 44 may be formed to be upright with respect to the mounting surface SM such that an angle between the internal coil pattern parts 42 and 44 and the mounting surface SM is between 80° to 100°.

Meanwhile, the internal coil pattern parts 42 and 44 may be disposed to be parallel to the first and second side surfaces SW1 and SW2 of the magnetic body 50, and the first and second side surfaces SW1 and SW2 may be mounted to be perpendicular with respect to the mounting surface SM of the printed circuit board 1100.

As described above, as the size of the thin type inductor 100 is reduced to 1608 size or smaller, the magnetic body 50 having the thickness T greater than the width W is formed.

Therefore, in the case in which the internal coil pattern parts 42 and 44 are formed to be perpendicular with respect to the mounting surface SM of the printed circuit board 1100, an area in which the internal coil pattern parts 42 and 44 may be formed may be increased, as compared to a case in which the internal coil pattern parts 42 and 44 are formed to be parallel to the mounting surface SM of the printed circuit board 1100. As the area in which the internal coil pattern parts 42 and 44 may be formed is increased, inductance (Ls) and quality factor (Q) may be improved.

However, in the cases of the 2012-sized chip (length: 2.0 mm×width: 1.2 mm), the 2520-sized chip (length: 2.5 mm×width: 2.0 mm), and the like, that are greater than the 1608-sized chip, since they are manufactured to a thickness tc of about 1 mm, similarly to the thickness tIC of the IC 500, they have a thickness T smaller than a width W thereof.

Therefore, in the thin type inductor having a size greater than the 1608 size, since the cross-sectional area of the magnetic body in the L-T direction is smaller than that of the magnetic body in the L-W direction, it is not preferable to dispose the internal coil pattern part to be perpendicular with respect to the mounting surface SM.

In the thin type inductor 100 having a 1608 size or smaller according to an exemplary embodiment, when the magnetic body 50 has a length of about 1.6±0.2 mm and a width of about 0.8±0.2 mm (1608 size), the magnetic body 50 may have the thickness T greater than the width W thereof in a range in which the thickness T is about 1.0±0.2 mm.

Further, when the magnetic body 50 has a length of about 1.0±0.2 mm and a width of about 0.5±0.2 mm (1005 size), the magnetic body 50 may have the thickness T greater than the width W thereof in a range in which the thickness is about 0.8±0.2 mm.

In addition, when the magnetic body 50 has a length of about 0.6±0.1 mm and a width of about 0.3±0.1 mm (0603 size), the magnetic body 50 may have the thickness T greater than the width W thereof in a range in which the thickness is about 0.5±0.2 mm.

Further, when the magnetic body 50 has a length of about 0.4±0.1 mm and a width of about 0.2±0.1 mm (0402 size), the magnetic body 50 may have the thickness T greater than the width W thereof in a range in which the thickness is about 0.3±0.2 mm.

However, the present invention is not limited thereto, and any thin type inductor including a magnetic body having a 1608 size or smaller and having a thickness greater than a width thereof may be included in the scope of the present invention.

In addition, as the internal coil pattern parts 42 and 44 are disposed to be perpendicular with respect to the mounting surface SM, an influence of the printed circuit board 1100 hindering a flow of magnetic flux may be significantly decreased.

That is, when the internal coil pattern parts 42 and 44 are formed to be parallel to the mounting surface SM, all flows of the magnetic flux may be hindered by the printed circuit board 1100. However, in the case in which the internal coil pattern parts 42 and 44 are disposed to be perpendicular with respect to the mounting surface SM according to an exemplary embodiment in the present disclosure, a flow of magnetic flux generated from a portion of internal coil pattern parts corresponding to an upper portion of the core part 71 may not be hindered by the printed circuit board 1100. Therefore, performance properties of the inductor such as inductance (Ls), quality factor (Q), and the like, may be improved.

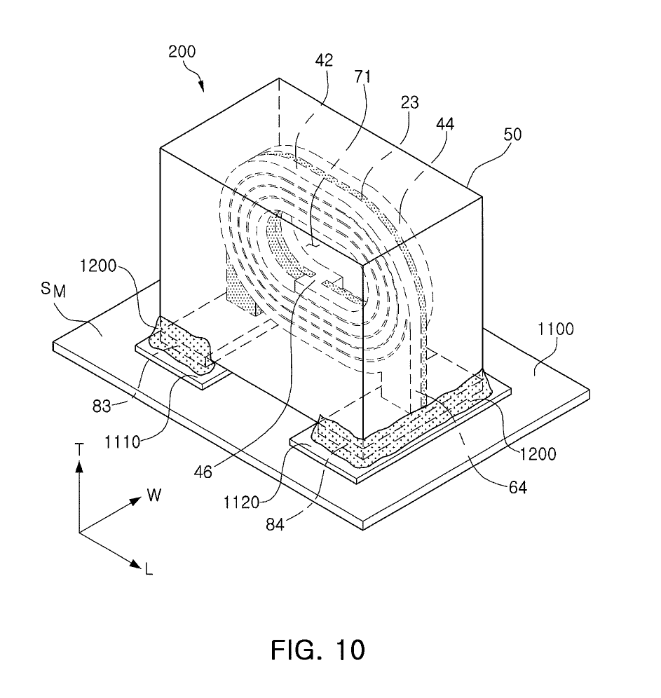

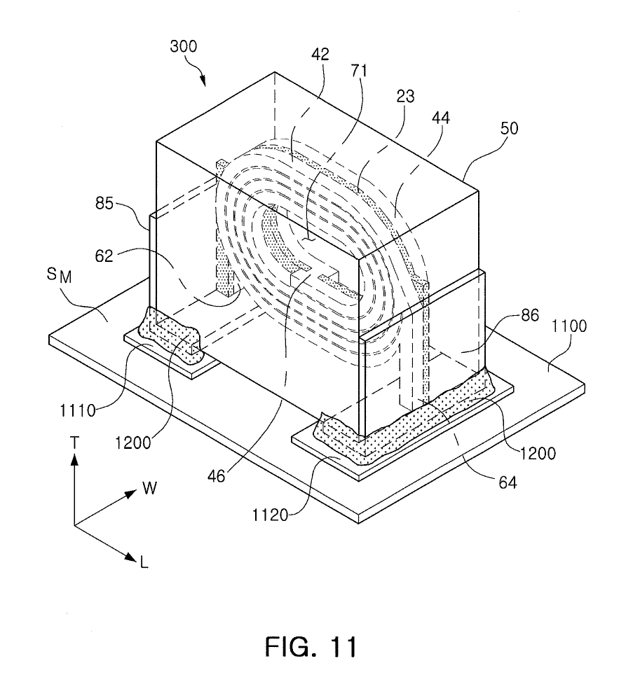

FIG. 10 is a perspective view illustrating a chip electronic component mounted on a board according to an exemplary embodiment. FIG. 11 is a perspective view illustrating a chip electronic component mounted on a board according to an exemplary embodiment.

Hereinafter, components different from those of the above-mentioned embodiments may be mainly described and a detailed description of the same components as those of the above-mentioned embodiments will be omitted.

Referring to FIG. 10, the first and second lead parts 62 and 64 extended from the end portion of internal coil pattern parts 44 and 42 may be led-out to the first main surfaces SB of the magnetic body 50, and the first and second external electrodes 83 and 84 may be disposed on the first main surface SB of the magnetic body 50 so as to be connected to the first and second lead parts 62 and 64.

Referring to FIG. 11, the first and second lead parts 62 and 64 extended from the end portion of internal coil pattern parts 44 and 42 may be led-out to the first and second end surfaces SL1 and SL2 of the magnetic body 50, respectively, simultaneously with being led-out to the first main surface SB of the magnetic body 50. The first external electrode 85 may be disposed on the first main surface SB of the magnetic body 50 and the first end surface SL1 thereof adjacent to the first main surface SB to be connected to the first lead part 62, and the second external electrode 86 may be disposed on the first main surface SB of the magnetic body 50 and the second end surface SL2 thereof adjacent to the first main surface SB to be connected to the second lead part 64.

The chip electronic component may be electrically connected to the printed circuit board 1100 by the soldering 1200 in a state in which the first external electrode 83 or 85 may be positioned on the first electrode pad 1110 to come into contact with the first electrode pad 1110 while the second external electrode 84 or 86 may be positioned on the second electrode pad 1120 to come into contact with the second electrode pad 1120.

In the case in which the external electrode is only formed on the first main surface SB of the magnetic body 50 or the external electrode is formed on the first main surface SB of the magnetic body 50 to be extended to the first or second end surfaces SL1 or SL2 thereof to thereby have an L-shape as illustrated in FIGS. 9 and 10, an influence of the external electrode hindering a flow of magnetic flux may be decreased, such that performance properties of the inductor may be further improved. Further, a parasitic capacitance component between the external electrode and the internal coil pattern part may be decreased.

The following Table 1 shows results obtained by comparing values of inductance (Ls) and direct current resistance (Rdc) of chip electronic components having a structure in which internal coil pattern parts were formed to be perpendicular with respect to a mounting surface of a board (“vertical structure”) according to an exemplary embodiment in the present disclosure as illustrated in FIGS. 9 and 10 and a chip electronic component having a structure in which internal coil pattern parts were formed to be parallel to a mounting surface of a board (“horizontal structure”) according to the related art.

(Length (L): 1.6 mm, width (W): 0.8 mm, thickness (T): 1.0 mm)

TABLE 1

| | FIG. 9 | FIG. 10 | Horizontal Structure |
|---|---|---|---|
| Ls (uH) | 0.4193 | 0.4597 | 0.288 |
| Rdc (mohm) | 88.65 | 83.35 | 83.41 |

As illustrated in Table 1, in the case of the chip electronic component of FIG. 9 in which the internal coil pattern part was formed to be perpendicular with respect to the mounting surface of the board, a degree of inductance (Ls) was significantly increased as compared to the case of the chip electronic component having a structure in which the internal coil pattern part was formed to be parallel to the mounting surface of the board according to the related art, and in the case of the chip electronic component of FIG. 10 in which the internal coil pattern parts 42 and 44 were formed to be perpendicular with respect to the mounting surface of the board and the external electrodes 83 and 84 were formed on the first main surface S_{B}, a degree of inductance (Ls) was further increased by about 70% as compared to the case of the chip electronic component according to the related art.

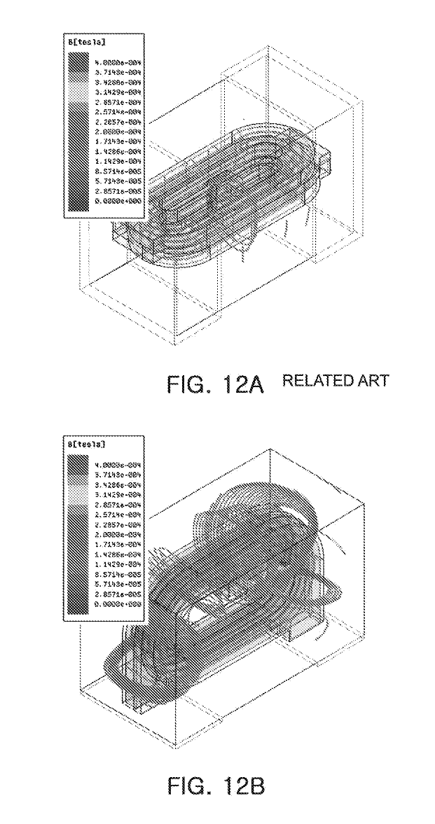

FIG. 12A is a view illustrating magnetic flux distribution in a chip electronic component in which internal coil pattern parts having a horizontal structure are formed according to the related art, and FIG. 12B is a view illustrating magnetic flux distribution in a chip electronic component in which internal coil pattern parts having a vertical structure are formed according to an exemplary embodiment, depending on a current applied to a coil.

In the case of the chip electronic component according to an exemplary embodiment (FIG. 12B), a flow of the magnetic flux generated from a portion of the internal coil pattern parts corresponding to the upper portion of the core part 71 may not be hindered by the printed circuit board, unlike the chip electronic component having the horizontal structure according to the related art (FIG. 12A).

The following Table 2 shows results obtained by comparing values of inductance (Ls) and direct current resistance (Rdc) of chip electronic components depending on sizes of thin type inductors and a vertical or horizontal structure of internal coil pattern parts (with respect to the mounting surface).

TABLE 2

| | | | Structure | | |
|---|---|---|---|---|---|
| | | | of | | |
| | | | Internal | | |
| | | | Coil | | |
| | | Length (L) × Width (W) × | Pattern | | Rdc |
| | Size | Thickness (T) | Part | Ls (uH) | (mohm) |
| 1 | 2520 | 2.5 mm × 2.0 mm × 1.0 mm | Vertical | 0.2109 | 21.00 |
| | | | Structure | | |
| 2 | 2520 | 2.5 mm × 2.0 mm × 1.0 mm | Horizontal | 0.4818 | 20.09 |
| | | | Structure | | |
| 3 | 2012 | 2.0 mm × 1.2 mm × 1.0 mm | Vertical | 0.4394 | 47.59 |
| | | | Structure | | |
| 4 | 2012 | 2.0 mm × 1.2 mm × 1.0 mm | Horizontal | 0.7022 | 46.82 |
| | | | Structure | | |
| 5 | 1608 | 1.6 mm × 0.8 mm × 1.0 mm | Vertical | 0.4193 | 88.65 |
| | | | Structure | | |
| 6 | 1608 | 1.6 mm × 0.8 mm × 1.0 mm | Horizontal | 0.2880 | 83.41 |
| | | | Structure | | |
| 7 | 1005 | 1.0 mm × 0.5 mm × 0.8 mm | Vertical | 0.50024 | 112.47 |
| | | | Structure | | |
| 8 | 1005 | 1.0 mm × 0.5 mm × 0.8 mm | Horizontal | 0.22704 | 111.34 |
| | | | Structure | | |
| 9 | 0603 | 0.6 mm × 0.3 mm × 0.5 mm | Vertical | 0.4210 | 212.00 |
| | | | Structure | | |
| 10 | 0603 | 0.6 mm × 0.3 mm × 0.5 mm | Horizontal | 0.1521 | 208.18 |
| | | | Structure | | |
| 11 | 0402 | 0.4 mm × 0.2 mm × 0.3 mm | Vertical | 0.3572 | 409.00 |
| | | | Structure | | |
| 12 | 0402 | 0.4 mm × 0.2 mm × 0.3 mm | Horizontal | 0.1142 | 405.08 |
| | | | Structure | | |

As illustrated in Table 2, in the cases of a 1608-sized component, a 1005-sized component, a 0603-sized component, and a 0402-sized component that are equal to or smaller than the 1608-sized component, when the internal coil pattern part had a vertical structure according to an exemplary embodiment in the present disclosure, a degree of inductance (Ls) was significantly increased.

However, in the cases of a 2012-sized component and a 2520-sized component that are greater than the 1608-sized component, when the internal coil pattern part had a horizontal structure rather than a vertical structure, inductance (Ls) and direct current resistance (Rdc) properties were excellent.

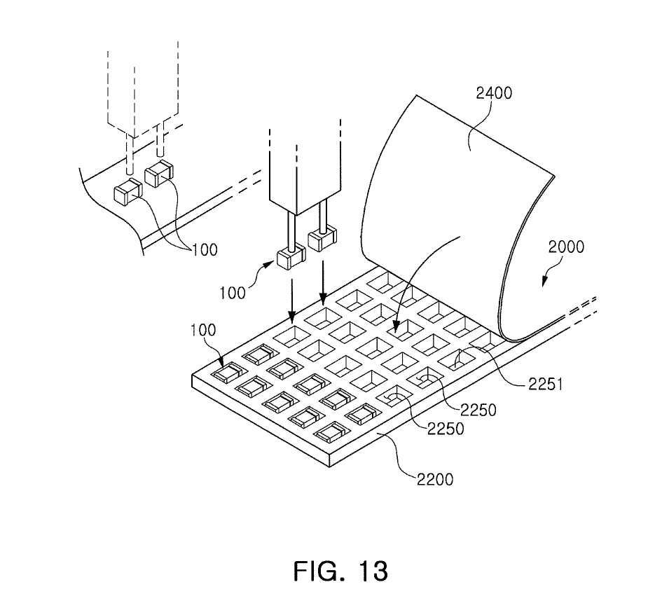

FIG. 13 is a schematic perspective view illustrating a form in which the chip electronic component according to an exemplary embodiment is mounted in a packaging unit.

Referring to FIG. 13, a packaging unit 2000 of a chip electronic component according to an exemplary embodiment may include a packaging sheet 2200 including a receiving part 2250 formed therein. In the receiving part 2250, the thin type inductor 100, a chip electronic component, is received.

The receiving part 2250 of the packaging sheet 2200 may have a shape corresponding to the thin type inductor 100.

In this case, the thin type inductor 100 may be disposed such that the internal coil pattern parts 42 and 44 are formed to be perpendicular with respect to a bottom surface 2251 of the receiving part 2250.

The thin type inductor 100 may be moved to the packaging sheet 2200 by a transfer apparatus while a state thereof in which the internal coil pattern parts 42 and 44 are arranged to be perpendicular with respect to the bottom surface of the receiving part is maintained through an electronic component arranging apparatus. Therefore, the internal coil pattern parts 42 and 44 may be disposed to be perpendicular with respect to the bottom surface 2251 of the receiving part 2250 of the packaging sheet 2200. By the method as described above, a plurality of thin type inductors 100 in the packaging sheet 2200 may be disposed to have the same directionality in the packaging sheet 2200.

Each of the thin type inductors 100 received in the receiving part 2250 may be disposed in such a manner that the first or second main surface SB or ST of the magnetic body 50 faces the bottom surface 2251 of the receiving part 2250.

The packaging unit 2000 of the chip electronic component may further include an enclosing layer 2400 covering the packaging sheet 2200 receiving the thin type inductor 100 in which the internal coil pattern parts 42 and 44 are disposed to be perpendicular with respect to the bottom surface 2251 of the receiving part 2250.

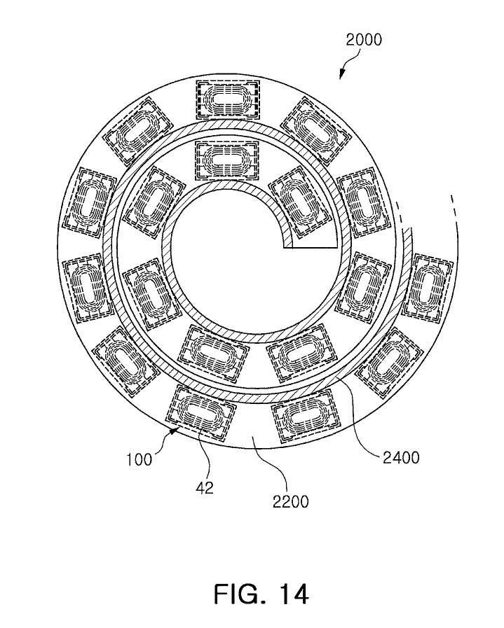

FIG. 14 is a schematic cross-sectional view illustrating a form in which the packaging unit of FIG. 13 is wound in a reel shape.

Referring to FIG. 14, the packaging unit 2000 of the chip electronic component, wound in a reel shape, may be formed in a continuously wound manner.

A description of contents of the packaging unit of the chip electronic component that are overlapped with those of the above-mentioned chip electronic component will be omitted in order to avoid an overlapped description.

As set forth above, according to exemplary embodiments, a chip electronic component capable of implementing high inductance (Ls) and an improved quality factor (Q) while having a reduced size thereof, a board having the same, and a packaging unit thereof may be provided.

While exemplary embodiments have been shown and described above, it will be apparent to those skilled in the art that modifications and variations could be made without departing from the scope of the present invention as defined by the appended claims.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A chip electronic component comprising:
a magnetic body having first and second main surfaces opposing each other in a thickness direction, first and second side surfaces opposing each other in a width direction, and first and second end surfaces opposing each other in a length direction, a thickness of the magnetic body being greater than a width thereof;
an internal coil pattern part disposed in the magnetic body; and
an external electrode disposed on at least one surface of the magnetic body,
wherein the internal coil pattern part is disposed to be perpendicular with respect to the first and second main surfaces of the magnetic body.

2. The chip electronic component of claim 1, wherein the magnetic body has about a 1608 size or smaller.

3. The chip electronic component of claim 1, wherein the internal coil pattern part is disposed to be parallel to the first and second side surfaces of the magnetic body.

4. The chip electronic component of claim 1, wherein the internal coil pattern part include a planar coil pattern formed on at least one surface of an insulation substrate by plating.

5. The chip electronic component of claim 1, wherein the internal coil pattern part include first and second lead parts extended from the end portion thereof and led-out to the first and second end surfaces of the magnetic body, respectively, and
the external electrode include first and second external electrodes disposed on the first and second end surfaces of the magnetic body, respectively, to be connected to the first and second lead parts, respectively.

6. The chip electronic component of claim 1, wherein the internal coil pattern part include first and second lead parts extended from the end portion thereof and led-out to the first main surface of the magnetic body, and
the external electrode include first and second external electrodes disposed on the first main surface of the magnetic body, to be connected to the first and second lead parts, respectively.

7. The chip electronic component of claim 1, wherein the internal coil pattern part include first and second lead parts extended from the end portion thereof and led-out to the first and second end surfaces of the magnetic body, respectively, simultaneously with being led-out to the first main surface of the magnetic body, and
the external electrode include a first external electrode disposed on the first main surface of the magnetic body and the first end surface thereof adjacent to the first main surface to be connected to the first lead part, and a second external electrode disposed on the first main surface of the magnetic body and the second end surface thereof adjacent to the first main surface to be connected to the second lead part.

8. A board having a chip electronic component, the board comprising:
a printed circuit board having electrode pads disposed thereon; and
a chip electronic component mounted on the printed circuit board such that an external electrode is positioned on the electrode pads,
wherein the chip electronic component includes a magnetic body having first and second main surfaces opposing each other in a thickness direction, first and second side surfaces opposing each other in a width direction, and first and second end surfaces opposing each other in a length direction, a thickness of the magnetic body being greater than a width thereof, an internal coil pattern part disposed in the magnetic body, and the external electrode disposed on at least one surface of the magnetic body, the internal coil pattern part being disposed to be perpendicular with respect to a mounting surface of the printed circuit board.

9. The board of claim 8, wherein the chip electronic component is mounted such that the first main surface of the magnetic body faces the mounting surface of the printed circuit board.

10. The board of claim 8, wherein the magnetic body has about a 1608 size or smaller.

11. The board of claim 8, further comprising: a semiconductor chip (IC) mounted on the printed circuit board,
wherein the chip electronic component has a thickness equal to or smaller than that of the semiconductor chip IC mounted on the printed circuit board.

12. The board of claim 8, wherein the internal coil pattern part include first and second lead parts extended from the end portion thereof and led-out to the first and second end surfaces of the magnetic body, respectively, and
the external electrode include first and second external electrodes disposed on the first and second end surfaces of the magnetic body, respectively, to be connected to the first and second lead parts, respectively.

13. The board of claim 8, wherein the internal coil pattern part include first and second lead parts extended from the end portion thereof and led-out to the first main surface of the magnetic body, and
the external electrode include first and second external electrodes disposed on the first main surface of the magnetic body, to be connected to the first and second lead parts, respectively.

14. The board of claim 8, wherein the internal coil pattern part include first and second lead parts extended from the end portion thereof and led-out to the first and second end surfaces of the magnetic body, respectively, simultaneously with being led-out to the first main surface of the magnetic body, and
the external electrode include a first external electrode disposed on the first main surface of the magnetic body and the first end surface thereof adjacent to the first main surface to be connected to the first lead part, and a second external electrode disposed on the first main surface of the magnetic body and the second end surface thereof adjacent to the first main surface to be connected to the second lead part.

15. A board having a chip electronic component, the board comprising:
a printed circuit board having electrode pads disposed thereon; and
a chip electronic component mounted on the printed circuit board such that an external electrode is connected to the electrode pads,
wherein the chip electronic component includes a magnetic body having first and second main surfaces opposing each other in a thickness direction, first and second side surfaces opposing each other in a width direction, and first and second end surfaces opposing each other in a length direction, a thickness of the magnetic body being greater than a width thereof, an internal coil pattern part disposed in the magnetic body, and the external electrode disposed on at least one surface of the magnetic body, the internal coil pattern part being disposed to be parallel to the first and second side surfaces of the magnetic body, and the first and second side surfaces of the magnetic body being mounted to be perpendicular with respect to a mounting surface of the printed circuit board.

16. The board of claim 15, wherein the magnetic body has about a 1608 size or smaller.

17. The board of claim 15, wherein a length of the magnetic body is about 1.6±0.2 mm and the width thereof is about 0.8±0.2 mm.

18. The board of claim 17, wherein the magnetic body has the thickness greater than the width thereof in a range in which the thickness is about 1.0±0.2 mm.

19. The board of claim 15, wherein a length of the magnetic body is about 1.0±0.2 mm and the width thereof is about 0.5±0.2 mm.

20. The board of claim 19, wherein the magnetic body has the thickness greater than the width thereof in a range in which the thickness is about 0.8±0.2 mm.

21. The board of claim 15, wherein a length of the magnetic body is about 0.6±0.1 mm and the width thereof is about 0.3±0.1 mm.

22. The board of claim 21, wherein the magnetic body has the thickness greater than the width thereof in a range in which the thickness is about 0.5±0.2 mm.

23. The board of claim 15, wherein a length of the magnetic body is about 0.4±0.1 mm and the width thereof is about 0.2±0.1 mm.

24. The board of claim 23, wherein the magnetic body has the thickness greater than the width thereof in a range in which the thickness is about 0.3±0.2 mm.

25. The board of claim 15, further comprising: a semiconductor chip (IC) mounted on the printed circuit board,
wherein the chip electronic component has a thickness equal to or smaller than that of the semiconductor chip IC mounted on the printed circuit board.

26. A packaging unit of a chip electronic component, the packaging unit comprising:
the chip electronic component of claim 1; and
a packaging sheet including a receiving part formed therein so as to receive the chip electronic component therein,
wherein the internal coil pattern part are disposed and arranged to be perpendicular with respect to a bottom surface of the receiving part.

27. The packaging unit of claim 26, wherein the chip electronic component received in the receiving part is disposed such that one of the first and second main surfaces of the magnetic body faces the bottom surface of the receiving part.
